(19) United States
(12) Patent Application Publication
(10) Pub. No.: US 2008/0106326 A1
(43) Pub. Date: May 8, 2008

(54) Reference voltage circuit and method for providing a reference voltage

(76) Inventor: Richard Gaggl, Poertschach (AT)

Correspondence Address: BRINKS HOFER GILSON & LIONE/INFINEON;INFINEON, PO BOX 10395, CHICAGO, IL, 60610, US

(21) Appl. No.: 11/593,376

(22) Filed: Nov. 6, 2006

(51) Int. Cl. G05F 3/22

(52) U.S. Cl. 327/539

(57) ABSTRACT

A high precision reference voltage circuit for generating a reference voltage includes a reference voltage generation circuit for generating a reference voltage, a temperature detection circuit for detecting a temperature at the reference voltage generation circuit, and a control circuit for controlling a temperature characteristic of the reference voltage generation circuit depending on the detected temperature. The reference voltage circuit may be a bandgap reference circuit for providing a bandgap voltage.

### BACKGROUND

1. Field of the Invention

The present invention relates to a reference voltage circuit, and more specifically to a bandgap voltage reference circuit. Furthermore, the present invention relates to a method for providing a reference voltage, and more specifically to a method for providing a bandgap reference voltage.

2. Description of the Related Art

Bandgap reference circuits are often used as a constant voltage source for analog and mixed signal integrated circuits. Conventional bandgap reference circuits attempt to achieve a relatively low temperature sensitivity or temperature dependency by using a circuit section having a positive temperature coefficient in combination with a circuit section having a negative temperature coefficient. In particular, in such a bandgap reference circuit a so-called PTAT voltage (positive to absolute temperature) is added to a so-called NTAT voltage (negative to absolute temperature) in such a way that the resulting output voltage of the bandgap reference circuit has a relatively low or negligible temperature coefficient. The PTAT voltage can, for example, be obtained as a voltage difference between two bipolar transistors which are operated with different current densities, whereas the NTAT voltage with the negative temperature coefficient may be obtained as a base-emitter voltage of a bipolar transistor. The temperature characteristic curve of such a bandgap reference circuit corresponds to a mirrored parabola. Alternatively, depending on the type of combination and generation of the PTAT and NTAT voltages, the temperature characteristic curve may be a polynomial function of a higher degree.

In such bandgap reference circuits, the vertex of the parabola or the polynomial function is determined such that it lies in or nearby the center of the specified temperature range of the bandgap reference circuit so as to minimize a deviation of the output voltage of the bandgap reference circuit depending on the temperature of the bandgap reference circuit, whereby typically the deviation is maximum at both end points or end regions of the parabola or polynomial function corresponding to the minimum and maximum temperature values of the specified temperature range of the bandgap reference circuit.

For most applications, the preciseness of the constant voltage provided by such a bandgap reference circuit has been sufficient, or the temperature deviation had to be accepted, and corresponding arrangements or measures had to be provided to deal with such temperature deviations, for example by providing calibrations, fusing, or specification restrictions etc. These measures, however, result in either a less stringent specification and increased complexity of the whole system, or the non-realizability of systems having very high temperature-stability requirements at low cost.

Consequently, there is a need for a bandgap reference circuit which overcomes the above-mentioned problems and allows to provide a precise bandgap voltage over an entire temperature range, whereby this need also exists for other reference voltage circuits configured for providing a particular reference voltage irrespective of whether the reference voltage is a bandgap voltage or not.

### SUMMARY

In accordance with various aspects of the present invention, a high precision, temperature compensated reference voltage circuit is provided. In accordance with an exemplary embodiment of the present invention, the reference voltage circuit is a bandgap reference voltage circuit.

In accordance with a first aspect of the present invention, the reference voltage circuit comprises a reference voltage generation circuit for generating a reference voltage, a temperature detection circuit for detecting a temperature at the reference voltage generation circuit, and a control circuit for controlling a temperature characteristic of the reference voltage generation circuit depending on the temperature detected by the temperature detection circuit.

According to another aspect of the present invention, a bandgap reference circuit is provided for providing a bandgap reference voltage. The bandgap reference circuit comprises a bandgap reference voltage generation circuit for generating a bandgap reference voltage, a temperature detection circuit for detecting a temperature at the bandgap reference voltage generation circuit or of the bandgap reference voltage generation circuit, and a control circuit or an adjustment circuit for controlling or adjusting a temperature characteristic of the bandgap reference voltage generation circuit depending on the temperature detected by the temperature detection circuit.

According to a further aspect of the invention, a corresponding method for providing a reference voltage, and a corresponding method for providing a bandgap reference voltage are provided.

In accordance with another aspect of the present invention, a reference voltage circuit is provided, comprising reference voltage generation means for generating a reference voltage, temperature detection means for detecting a temperature at or of the reference voltage generation means, and control means for controlling a temperature characteristic of the reference voltage generation means depending on the temperature detected by the temperature detection means.

According to an exemplary embodiment, the invention is used in a bandgap reference circuit comprising a first circuit portion having a positive temperature coefficient and a second circuit portion having a negative temperature coefficient.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic diagram showing a reference voltage circuit according to an embodiment of the invention;

FIG. 2 shows a circuit diagram of a bandgap reference circuit according to an exemplary embodiment of the invention;

FIG. 3 shows several views for illustrating an adjustment of a temperature characteristic curve, which may be used in the circuit of FIG. 1 or FIG. 2, according to an embodiment of the invention;

FIG. 4 shows a temperature detection circuit which may be used in or in combination with the circuit of FIG. 1 or FIG. 2 according to an exemplary embodiment of the invention; and

FIG. 5 shows an output voltage of the temperature detection circuit shown in FIG. 4 as a function of the temperature.

### DETAILED DESCRIPTION

According to an aspect of the present invention, a reference voltage circuit is provided, which comprises a voltage generation circuit for generating a reference voltage, a temperature detection circuit for detecting a temperature at the reference voltage generation circuit or of the reference voltage generation circuit, and a control circuit for controlling or adjusting a temperature characteristic of the temperature generation circuit depending on the detected temperature.

By measurement and evaluation of the actual temperature at the integrated circuit comprising the voltage generation circuit, the temperature characteristic of the reference voltage circuit can be adjusted or programmed such that the deviation of the generated output voltage depending on the temperature is restricted. According to an embodiment, the temperature characteristic curve of the reference voltage generation circuit is a parabola or a polynomial function having a higher degree, and depending on the detected temperature the vertex of the function is shifted such that it lies in a temperature range comprising the detected temperature value. According to another embodiment, the vertex of the function is shifted towards the detected temperature. Thereby, the preciseness of the generated reference voltage can be improved over the entire temperature range.

Consequently, a highly precise output voltage can be generated without increased complexity of the whole system, and in particular this reference voltage circuit can be manufactured at low cost by keeping the strict conditions of the corresponding specification over the entire temperature range.

According to an embodiment of the invention, the temperature characteristic of the reference voltage generation circuit is adjusted or controlled such that the temperature dependency of the output voltage or reference voltage generated by the reference voltage generation circuit is minimized. According to another embodiment, this can be achieved by an automatic adjustment or programming of the reference voltage circuit by the control circuit.]

According to a further embodiment, the reference voltage circuit is a bandgap reference circuit, and the reference voltage generation circuit is a bandgap reference voltage generation circuit, especially a bandgap reference voltage generation circuit comprising a circuit section having a positive temperature coefficient and a circuit section having a negative temperature coefficient, whereby one or more current densities of these circuit sections are automatically adapted so as to adjust the temperature characteristic of the temperature generation circuit accordingly. Especially, according to an exemplary embodiment, this can be achieved by adapting the resistance of a resistor in at least one of two circuit sections. Alternatively, any other circuit component may be varied accordingly so as to achieve this object.

According to an embodiment of the invention, this adjustment is performed especially with respect to the circuit section having the positive temperature coefficient.

In the following, an embodiment of the present invention will be described with respect to the use of the present invention for a bandgap reference circuit. However, as a matter of course, the present invention is not restricted to this special use, but the invention can be applied to any reference voltage circuits comprising a reference voltage generation circuit for providing a reference voltage of any type.

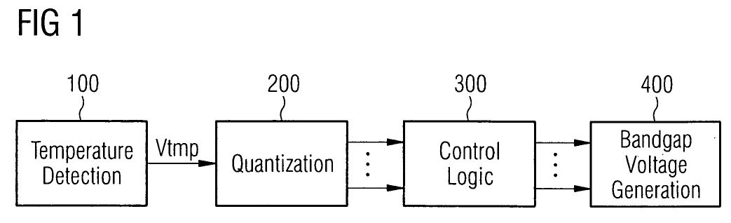

FIG. 1 shows a block diagram of a bandgap reference circuit according to an embodiment of the present invention. According to the embodiment shown in FIG. 1, the bandgap reference circuit comprises a temperature detection circuit 100, a quantization circuit 200, a control logic 300, and a bandgap reference voltage generation circuit 400. All components may be provided on a common semiconductor chip.

The bandgap reference voltage generation circuit 400, for example, comprises a first circuit section having a positive temperature coefficient (PTAT circuit section) so that the first circuit section generates an output voltage which increases as the temperature rises. Furthermore, the bandgap reference voltage generation circuit 400, for example, comprises a second circuit section having a negative temperature coefficient (NTAT circuit section) with generates an output voltage that decreases as the temperature increases. The output voltages of both circuit sections may be derived from base-emitter voltages of corresponding bipolar transistors. By an appropriate combination of the output voltages of the first and second circuit sections the bandgap reference voltage can be generated which is relatively constant over the temperature and does not show any or only a negligible temperature dependency.

The temperature characteristic curve of such a bandgap reference voltage generation circuit 400 corresponds to a mirrored parabola or a polynomial function having a higher degree. In the following, to simplify matters, it is assumed that the bandgap reference voltage generation circuit 400 has a parabola as a temperature characteristic curve. The deviation of the reference voltage value at the vertex of the parabola towards the reference voltage generated at a temperature corresponding to both end portions of the parabola may typically amount up to 20 mV.

In order to eliminate this residual temperature dependency of the reference voltage generated by the bandgap reference voltage generation circuit 400, the temperature detection circuit 100 of FIG. 1 monitors and detects the temperature existing immediately nearby or at the bandgap reference voltage generation circuit 400, that is the temperature detection circuit 100 detects the temperature of the bandgap reference voltage generation circuit 400 immediately at the semiconductor chip of the bandgap reference voltage generation circuit 400, for example, if the latter is formed as an integrated circuit in a semiconductor chip. The temperature detection circuit 100 generates an output voltage Vtmp corresponding to the temperature of the bandgap reference voltage generation circuit 400.

The quantization circuit 200 receives the output voltage of the temperature detection circuit 100 and generates a quantized or digitalized output signal corresponding to the output voltage Vtmp. According to an embodiment of the invention, the quantization circuit 200 may only comprise a comparator for quantizing the output voltage Vtmp.

The quantized output voltage Vtmp is supplied to the control logic 300 which controls the bandgap reference voltage generation circuit 400 such that the maximum deviation of the temperature dependency of the bandgap reference voltage generated by the bandgap reference voltage generation circuit 400 is reduced over the entire range of temperature. In particular, according to an embodiment, the control logic 300 adjusts or programs the bandgap reference voltage generation circuit 400 such that the vertex of the mirrored parabola of the temperature characteristic curve of the bandgap reference voltage generation circuit 400 is shifted to minimize the deviation of the temperature dependency of the temperature characteristic curve in a predetermined temperature range comprising the specific temperature detected by the temperature detection circuit 100. According to another embodiment, the control logic 300 adjusts or programs the bandgap reference voltage generation circuit 400 depending on the quantized voltage Vtmp such that the vertex of the parabola of the temperature characteristic curve of the bandgap reference voltage generation circuit 400 is shifted to lie at least nearby the detected temperature corresponding to the quantized voltage Vtmp.

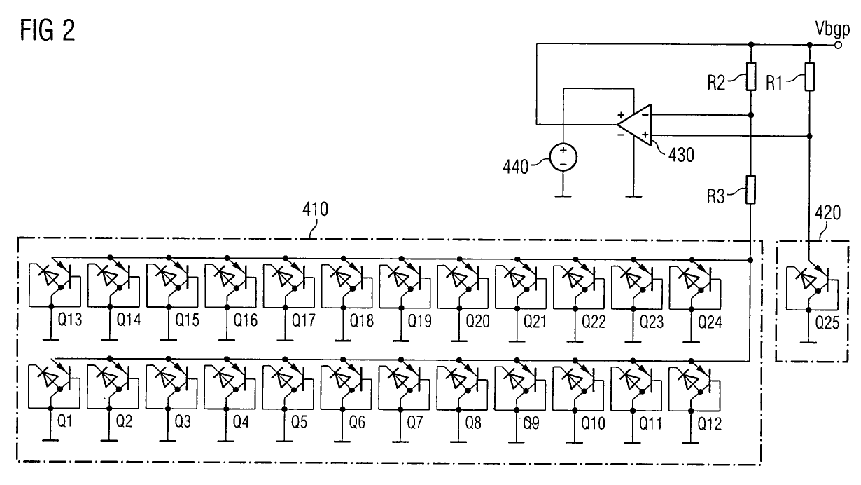

FIG. 2 shows a circuit diagram of a possible implementation of the bandgap reference voltage generation circuit 400 according to an embodiment of the invention. The bandgap reference voltage generation circuit 400 of this embodiment comprises a first circuit section or PTAT circuit section 410 generating an output voltage having a positive temperature coefficient, this first circuit section 410 comprising 24 (parasitic) bipolar transistors Q1-Q24 being connected as shown in FIG. 2. The base and collector terminals of each bipolar transistor Q1-Q24 are connected to one another so that, as a result, 24 pn junctions of the bipolar transistors Q1-Q24 are connected in parallel between a resistor R3 and ground potential. The first circuit section 410 generates a PTAT output voltage having a positive temperature coefficient as a difference voltage between two base emitter voltages of bipolar transistors being operated with different current densities (e single base emitter voltage has a NTAT behavior or a negative temperature coefficient). Furthermore, the bandgap reference voltage generation circuit 400 comprises a second circuit section or an NTAT circuit section 420 which, according to this embodiment, comprises a parasitic bipolar transistor Q25, whereby the base and collector terminals are again connected to one another so that the pn-junction between the emitter and the base of the bipolar transistor Q25 is connected between a resistor R1 and ground potential. The resistor R3 is connected to a further resistor R2 which may have the same resistance as the resistor R1. The node between the resistors R2 and R3 on the one hand and the node between the resistor R1 and the emitter of the bipolar transistor Q25 on the other hand are connected to differential input terminals of a differential operational amplifier 430 which is operated by a voltage source 440. The output terminal of the differential operational amplifier 430 is connected to both resistors R1, R2 and supplies a bandgap reference voltage Vbgp.

As can be taken from the circuit diagram depicted in FIG. 2, the current density in the current path from resistor R3 to ground is 24 times the current density in the current path from the resistor R1 to ground potential since the effective base emitter area of the bipolar transistors Q1-Q24 is 24 times the effective base emitter area of the bipolar transistor Q25. The bandgap reference voltage generation circuit 400 may, for example, be manufactured in CMOS technology using only parasitic bipolar transistors having a relatively small current amplification. In order to allow a stable manufacturing of such a bandgap reference voltage generation circuit in a CMOS technology, such a ratio of the effective base emitter areas in both current paths is advantageous, whereby the total number of 25 parasitic bipolar transistors Q1-Q25 may be manufactured in an array of 5×5 bipolar devices, which allows a very good matching of the individual bipolar devices and the bandgap reference voltage generation circuit 400.

As can be also taken from the circuit diagram of FIG. 2, the output voltage Vbgp of the bandgap reference voltage generation circuit 400 is obtained by generating a difference voltage between the output voltage of the second circuit section 420 and the output voltage of the first circuit section 410.

As already discussed above with respect to FIG. 1, the control logic 300 controls or programs the bandgap reference voltage generation circuit 400 such that the vertex of the parabola of the temperature characteristic curve of the bandgap reference voltage generation circuit 400 is shifted towards the temperature at the bandgap reference voltage generation circuit 400 as detected by the temperature detection circuit 100. In general, the structure of the control logic 300 can be of any type as long as it allows adjusting the temperature characteristic curve of the bandgap reference voltage generation circuit 400 in an appropriate manner.

However, according to an embodiment of the invention, the control logic 300 and the bandgap reference voltage generation circuit 400 are designed such that the control logic 300 adjusts the resistance of the resistor R3 of the bandgap reference voltage generation circuit 400 shown in FIG. 2 so as to adjust the vertex of the parabola of the temperature characteristic curve accordingly. When, in addition, the resistances of the resistors R1 and R2 are adapted accordingly at the same time, the absolute value of the bandgap reference voltage Vbgp can be re-adjusted to its desired absolute value.

In general, the temperature characteristic curve can be adjusted by the control logic 300 by adjusting or adapting the current densities in both current paths of the first and second circuit sections 410, 420 of the bandgap reference voltage generation circuit 400 accordingly. While several different concepts are possible to achieve this object, from a circuitry perspective the adjustment of the temperature characteristic curve by the adaptation of at least one of the resistors R1-R3 shown in FIG. 2 is the option that is easiest to implement.

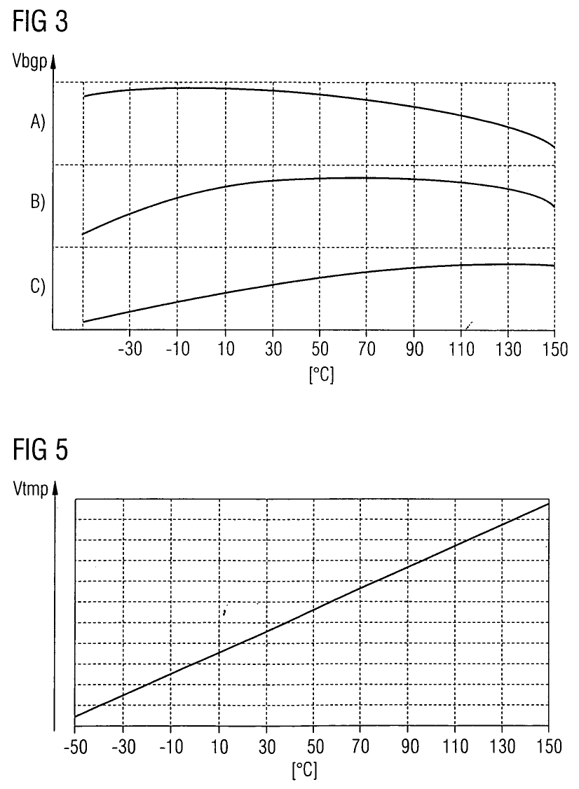

FIG. 3 shows several temperature characteristic curves associated with the bandgap reference voltage Vbgp as generated by the bandgap reference voltage generation circuit shown in FIG. 1 or FIG. 2. According to FIG. 3A, the bandgap reference voltage generation circuit 400 has been programmed such that the vertex of the parabola of the temperature characteristic curve has been shifted to a temperature of about 0° C., while according to FIG. 3B the vertex of the parabola has been shifted to a temperature of about 65° C., and according to FIG. 3C the vertex has been shifted to a temperature of about 150° C., in each case in conformity with and in dependence on the temperature as detected by the temperature detection circuit 100.

By the measurement of the temperature present at the bandgap reference voltage generation circuit 400 and by means of the known temperature characteristic of the bandgap reference voltage, the preciseness of the generated temperature reference voltage can be increased significantly. Since the invention allows providing a temperature compensated reference voltage, all operating parameters derived from such a reference voltage can be improved. This, for example, can be a gain error of an analog/digital converter and a digital/analog converter which may be caused by the temperature dependency of the corresponding reference voltage (which in turn can be derived from a bandgap reference voltage).

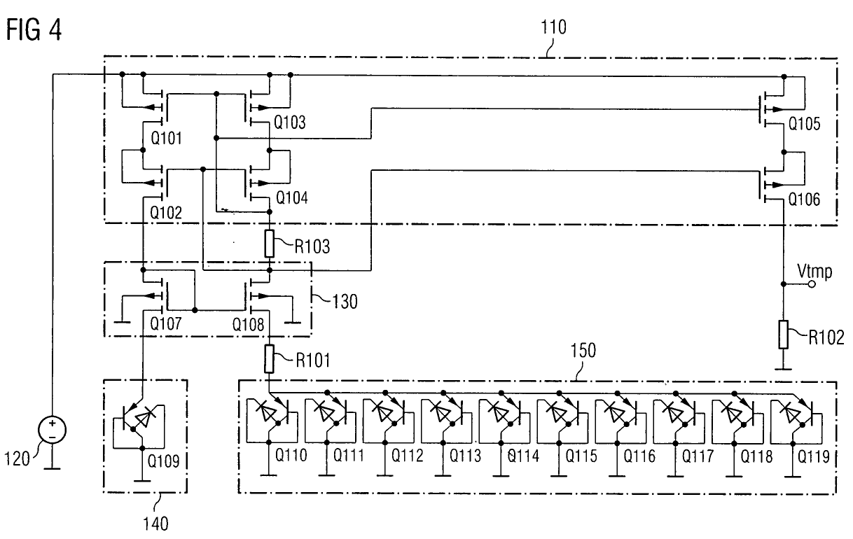

FIG. 4 shows a circuit diagram of the temperature detection circuit 100 according to an embodiment of the invention. In particular, this embodiment can be easily implemented using a standard CMOS process (130 nm) using a parasitic vertical pnp bipolar transistor for generating a diode voltage.

The temperature detection circuit 100 shown in FIG. 4 comprises a current mirror circuit 110 operated by a voltage source 120. The current mirror circuit 110 comprises six MOS transistors Q101-Q106 which are connected as shown in FIG. 4. This structure of the current mirror circuit 110 is also called a “wide-swing current mirror circuit”. In addition, the temperature detection circuit 100 comprises a second current mirror circuit 130 comprising two MOS transistors Q107, Q108. Both current mirror circuits 110 and 130 are degenerated through a resistor R103 so that the temperature detection circuit 100 assumes a desired operating point. The MOS transistor Q107 is coupled to a first bipolar circuit section 140, while the MOS transistor Q108 is coupled through a resistor R101 to a second bipolar circuit section 150. If the first and second bipolar circuit sections 140, 150 are designed such that they are operated with different current densities, a PTAT property can be achieved. To increase this PTAT property, larger emitter area ratios can be chosen. In the embodiment of FIG. 4, the emitter area ratio between the first bipolar circuit section 140 and the second bipolar circuit section 150 is 1:10 as the first bipolar circuit section 140 comprises only one pnp bipolar transistor Q107, while the second bipolar circuit section 150 comprises ten pnp bipolar transistors Q108-Q117, which are each interconnected as shown in FIG. 4 and which have each their base end collector terminals connected to one another. Furthermore, the temperature detection circuit 100 comprises a resistor R102 at which the mirrored current causes a voltage drop Vtmp which is proportional to the absolute temperature. Thereby, in addition, the dependency of the resistors R101-R103 from the temperature can be compensated for.

As explained above, the output voltage Vtmp of the temperature detection circuit 100 is proportional to the absolute temperature and, for example, can be dimensioned such that it increases by 1 mV if the temperature changes by 1° C., as depicted in FIG. 5 which shows the output voltage Vtmp of the temperature detection circuit 100 as a function of the temperature over a temperature range from −50° C. to 150° C. according to an embodiment of the invention.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. A reference voltage circuit, comprising:
a reference voltage generation circuit which generates a reference voltage;
a temperature detection circuit which detects a temperature at the reference voltage generation circuit; and
a control circuit which controls a temperature characteristic of the reference voltage generation circuit depending on the temperature detected by the temperature detection circuit.

2. The reference voltage circuit according to claim 1, wherein the control circuit controls the temperature characteristic of the reference voltage generation circuit by shifting the temperature characteristic curve of the reference voltage generation circuit.

3. The reference voltage circuit according to claim 1, wherein the reference voltage generation circuit has a parabola as a temperature characteristic curve, and wherein the control circuit controls the temperature characteristic of the reference voltage generation circuit by shifting a vertex of the parabola of the temperature characteristic curve of the reference voltage generation circuit towards the temperature detected by the temperature detection circuit.

4. The reference voltage circuit according to claim 1, wherein the reference voltage generation circuit has a polynomial function as a temperature characteristic curve, and wherein the control circuit controls the temperature characteristic of the reference voltage generation circuit by shifting the polynomial function of the temperature characteristic curve of the reference voltage generation circuit such that a temperature dependency of the reference voltage generation circuit at the temperature detected by the temperature detection circuit is reduced.

5. The reference voltage circuit according to claim 1, wherein the control circuit controls the temperature characteristic of the reference voltage generation circuit by adjusting a circuit component of the reference voltage generation circuit.

6. The reference voltage circuit according to claim 1, wherein the control circuit controls the temperature characteristic of the reference voltage generation circuit by adjusting a current density in a current path of the voltage generation circuit.

7. The reference voltage circuit according to claim 1, wherein the reference voltage generation circuit is a bandgap reference voltage generation circuit for generating a bandgap voltage as the reference voltage.

8. A bandgap reference circuit, comprising:
a bandgap voltage generation circuit for generating a bandgap voltage;
a temperature detection circuit for detecting a temperature at the bandgap voltage generation circuit; and
an adjustment circuit for adjusting a temperature characteristic of the bandgap voltage generation circuit depending on the temperature detected by the temperature detection circuit.

9. The bandgap reference circuit according to claim 8, wherein the adjustment circuit adjusts the temperature characteristic of the bandgap voltage generation circuit by shifting a temperature characteristic curve of the bandgap voltage generation circuit.

10. The bandgap reference circuit according to claim 8, wherein the bandgap voltage generation circuit has a parabola as a temperature characteristic curve of the bandgap voltage generation circuit, and wherein the adjustment circuit adjusts the temperature characteristic of the bandgap voltage generation circuit by shifting a vertex of the parabola of the temperature characteristic curve of the bandgap voltage generation circuit towards the temperature detected by the temperature detection circuit.

11. The bandgap reference circuit according to claim 8, wherein the bandgap voltage generation circuit has a polynomial function as a temperature characteristic curve, and wherein the adjustment circuit adjusts the temperature characteristic of the bandgap voltage generation circuit by shifting the polynomial function of the temperature characteristic curve of the bandgap voltage generation circuit such that a temperature dependency of the bandgap voltage generation circuit at the temperature detected by the temperature detection circuit is reduced.

12. The bandgap reference circuit according to claim 8, wherein the adjustment circuit adjusts the temperature characteristic of the bandgap voltage generation circuit by adjusting a circuit component of the bandgap voltage generation circuit.

13. The bandgap reference circuit according to claim 8, wherein the adjustment circuit adjusts the temperature characteristic of the bandgap voltage generation circuit by adjusting a current density in a current path of the bandgap voltage generation circuit.

14. A reference voltage circuit, comprising:
reference voltage generation means for generating a reference voltage;
temperature detection means for detecting a temperature at the reference voltage generation means; and
control means for controlling a temperature characteristic of the reference voltage generation means depending on the temperature detected by the temperature detection means.

15. A method for providing a reference voltage, comprising the steps of
generating a reference voltage using a reference voltage generation circuit;
detecting a temperature at the reference voltage generation circuit; and
controlling a temperature characteristic of the reference voltage generation circuit depending on the detected temperatures of the reference voltage generation circuit.

16. The method according to claim 15, further comprising the step of controlling the temperature characteristic of the reference voltage generation circuit by shifting a temperature characteristic curve of the reference voltage generation circuit towards the detected temperature.

17. The method according to claim 15, wherein the reference voltage generation circuit has a parabola as a temperature characteristic curve and further comprising the step of controlling the temperature characteristic of the reference voltage generation circuit by shifting a vertex of the parabola of the temperature characteristic curve towards the detected temperature.

18. The method according to claim 15, wherein the reference voltage generation circuit has a polynomial function as a temperature characteristic curve and further comprising the step of controlling the temperature characteristic of the reference voltage generation circuit by shifting the polynomial function of the temperature characteristic curve such that a temperature dependency of the reference voltage generation circuit is reduced at the detected temperature.

19. The method according to claim 15, further comprising the step of controlling the temperature characteristic of the reference voltage generation circuit by adjusting a circuit component of the reference voltage generation circuit.

20. The method according to claim 15, further comprising the step of controlling the temperature characteristic of the reference voltage generation circuit by adjusting a current density of a current path of the reference voltage generation circuit.

21. A method for providing a bandgap voltage comprising the steps of:
generating a bandgap voltage using a bandgap voltage generation circuit;
detecting a temperature at the bandgap voltage generation circuit; and
adjusting a temperature characteristic of the bandgap voltage generation circuit depending on the detected temperature.

22. The method according to claim 21, further comprising the step of adjusting the temperature characteristic of the bandgap voltage generation circuit by shifting a temperature characteristic curve of the bandgap voltage generation circuit towards the detected temperature.

23. The method according to claim 21, wherein the bandgap voltage generation circuit has a parabola as a temperature characteristic curve and further comprising the step of adjusting the temperature characteristic of the bandgap voltage generation by shifting a vertex of the parabola of the temperature characteristic curve towards the detected temperature.

24. The method according to claim 21, wherein the bandgap voltage generation circuit has a polynomial function as a temperature characteristic curve, and further comprising the step of adjusting the temperature characteristic of the bandgap voltage generation circuit by shifting the polynomial function of the temperature characteristic curve such that a temperature dependency of the bandgap voltage generation circuit is reduced at the detected temperature.

25. The method according to claim 21, further comprising the step of adjusting the temperature characteristic of the bandgap voltage generation circuit by adjusting a resistor of the bandgap voltage generation circuit.

26. The method according to claim 21, further comprising the step of adjusting the temperature characteristic of the bandgap voltage generation circuit by adjusting a current density in a current path of the bandgap voltage generation circuit.

27. A method for providing a reference voltage, comprising the steps of:
generating a reference voltage is using a reference voltage generation circuit;
detecting a temperature of the reference voltage generation circuit; and
controlling a temperature characteristic of the temperature generation circuit depending on the detected temperature such that a variation of a temperature dependency of the reference voltage generation circuit in a temperature range nearby the detected temperature is reduced.
